(19) United States
(12) Patent Application Publication
(10) Pub. No.: US 2026/0063421 A1
(43) Pub. Date: Mar. 5, 2026

(54) THREE-AXIS YAW RATE SENSOR COMRISING A SENSOR SUBSTRATE AND A DOUBLE ROTOR AND A FIRST SPRING STRUCTURE AND A SECOND SPRING STRUCTURE

(71) Applicant: Robert Bosch GmbH, Stuttgart (DE)

(72) Inventor: Matthias Wenzel, Marbach Am Neckar (DE)

(21) Appl. No.: 19/312,415

(22) Filed: Aug. 28, 2025

(30) Foreign Application Priority Data
Sep. 5, 2024 (DE) 10 2024 208 420.4

(51) Int. Cl. G01C 19/5733

(52) U.S. Cl. CPC G01C 19/5733

(57) ABSTRACT

A three-axis yaw rate sensor. The sensor includes a sensor substrate, a double rotor, and a first and a second spring structure, the substrate having a main extension plane, the main extension plane being spanned by an X-axis and a Y-axis oriented perpendicularly to the X-axis, a Z-axis being oriented perpendicularly to the main extension plane, the double rotor having a first and a second rotor, the first rotor having a first and a second seismic mass, the second rotor having a third and fourth seismic mass, the first rotor being connected to the sensor substrate via a first substrate connection, the second rotor being connected to the sensor substrate via a second substrate connection, the first rotor being connected to the second rotor via the first spring structure in such a way that a first mechanical coupling is present between the first and the second rotor.

### FIELD The present invention relates to a yaw rate sensor comprising a first rotor and a second rotor and a sensor substrate.

### BACKGROUND INFORMATION

Modern micromechanical yaw rate sensor arrangements, cf. German Patent Application Nos. DE 10 2020 205 372 A1 and DE 10 2021 200 483 A1, have two rotor masses arranged in one plane, which are mechanically coupled via webs.

### SUMMARY

It is an object of the present invention to provide a three-axis yaw rate sensor comprising a sensor substrate, a double rotor and a first spring structure and a second spring structure, which yaw rate sensor has the following advantages.

The three-axis yaw rate sensor according to an example embodiment of the present invention (hereinafter also referred to as yaw rate sensor), comprising a sensor substrate and comprising a double rotor having a first rotor and a second rotor, and a first spring structure and a second spring structure, has the advantage over the related art that it is robust and insensitive to rotational accelerations about all three spatial axes, and at the same time manages with spring structures for mechanical coupling that are significantly thicker and thus more resistant and break-proof, which leads to lower failure rates.

In this case, the measurement of the yaw rates about the three spatial axes (an X-axis, a Y-axis and a Z-axis) is carried out by measuring the deflection of detection modes of the yaw rate sensor. A detection mode which is excited by a rotation about the X-axis is also referred to below as X-detection mode. A detection mode which is excited by a rotation about the Y-axis is also referred to below as Y-detection mode. A detection mode which is excited by a rotation about the Z-axis is also referred to below as Z-detection mode. The resulting measurement channels for the yaw rates about the three spatial axes are also referred to below as X, Y and Z channels.

Advantageous embodiments and developments of the present invention are disclosed herein.

According to an advantageous embodiment of the present invention, it is provided that the yaw rate sensor has a first spring structure and/or a second spring structure which is made of and/or arranged in a polycrystalline silicon layer produced by epitaxial growth, the polycrystalline silicon layer having a thickness between 10 μm and 100 μm.

According to a further advantageous embodiment of the present invention, it is provided that the first and the second spring structure are arranged in such a way that they do not cross at any point, from the perspective of a directional axis oriented perpendicularly to the main extension plane of the sensor substrate.

According to a further advantageous embodiment of the present invention, it is provided that the first and the second spring structure are arranged in such a way that they do not obscure one another at any point, from the perspective of a directional axis oriented perpendicularly to the main extension plane of the sensor substrate.

According to a further advantageous embodiment of the present invention, it is provided that the first spring structure is arranged in such a way that it extends on the outside of the yaw rate sensor.

According to a further advantageous embodiment of the present invention, it is provided that a mechanical coupling of the Z-detection mode takes place on the inside across the sensor center.

According to a further advantageous embodiment of the present invention, it is provided that the substrate connections of the yaw rate sensor, in particular the substrate connections of the second spring structure, are arranged in the sensor center, which causes smaller differential length changes upon deformation or expansion of the underlying sensor substrate, resulting in smaller changes in sensitivity and offset upon change in external environmental conditions.

According to a further advantageous embodiment of the present invention, it is provided that the first spring structure couples a drive movement and an X-detection movement by means of U-shaped spring elements, as a result of which an anti-parallel drive mode and an anti-parallel detection mode for the X-channel are created.

According to a further advantageous embodiment of the present invention, it is provided that a mechanical coupling of the Y-detection mode is provided by a second spring structure designed as a torsion rocker.

According to a further advantageous embodiment of the present invention, it is provided that a movement of the rotors out of the plane is possible by means of a substrate connection arranged on an axis of symmetry of the yaw rate sensor.

According to a further advantageous embodiment of the present invention, it is provided that a mechanical coupling of the Z-detection mode is provided by the second spring structure.

According to a further advantageous embodiment of the present invention, it is provided that the second spring structure has at least one first spring element, preferably four spring elements, which is or are designed as an S-shaped spring or springs, as a result of which a movement of the drive mode is made possible and at the same time radial movements of seismic masses in the rotors are transmitted to the second spring structure, in particular to the torsion rocker.

According to a further advantageous embodiment of the present invention, it is provided that the seismic masses located in one half of the yaw rate sensor, from the perspective of a directional axis oriented perpendicularly to the main extension plane of the sensor substrate, are coupled to the seismic masses located in another half of the yaw rate sensor via at least one second spring element designed as an H-shaped spring. In this case, the dividing line between one half and the other half extends along an axis extending through the center points of the first and the second substrate connection of the rotors.

According to a further advantageous embodiment of the present invention, it is provided that the sensor substrate is a MEMS substrate.

Exemplary embodiments of the present invention are illustrated in the figures and explained in more detail in the following description.

### BRIEF DESCRIPTION OF THE DRAWINGS

FIG. 1 shows a schematic representation of a three-axis yaw rate sensor according to a first embodiment of the present invention in plan view, and three more detailed representations of spring elements of this first embodiment.

FIG. 2 shows a schematic representation of the drive mode of the three-axis yaw rate sensor according to the first embodiment of the present invention in plan view.

FIG. 3A shows a schematic representation of a detection mode of the three-axis yaw rate sensor according to the first embodiment of the present invention, which mode is excited by a rotation about the X-axis.

FIG. 3B shows a schematic representation of a detection mode of the three-axis yaw rate sensor according to the first embodiment of the present invention, which mode is excited by a rotation about the Y-axis.

FIG. 3C shows a schematic representation of a detection mode of the three-axis yaw rate sensor according to the first embodiment of the present invention, which mode is excited by a rotation about the Z-axis.

### DETAILED DESCRIPTION OF EXAMPLE EMBODIMENTS

In the various figures, identical parts are always provided with the same reference signs and are therefore generally also named or mentioned only once.

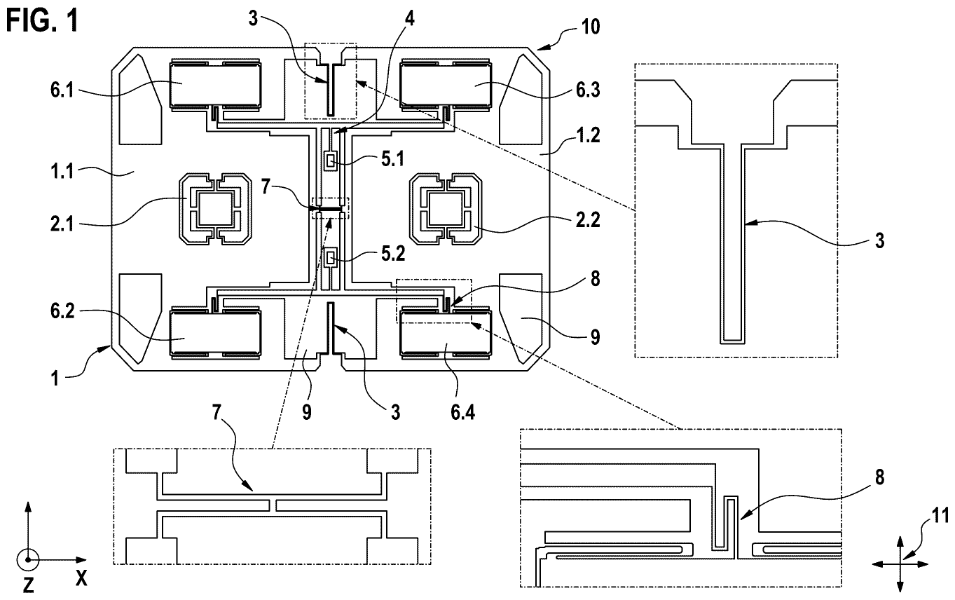

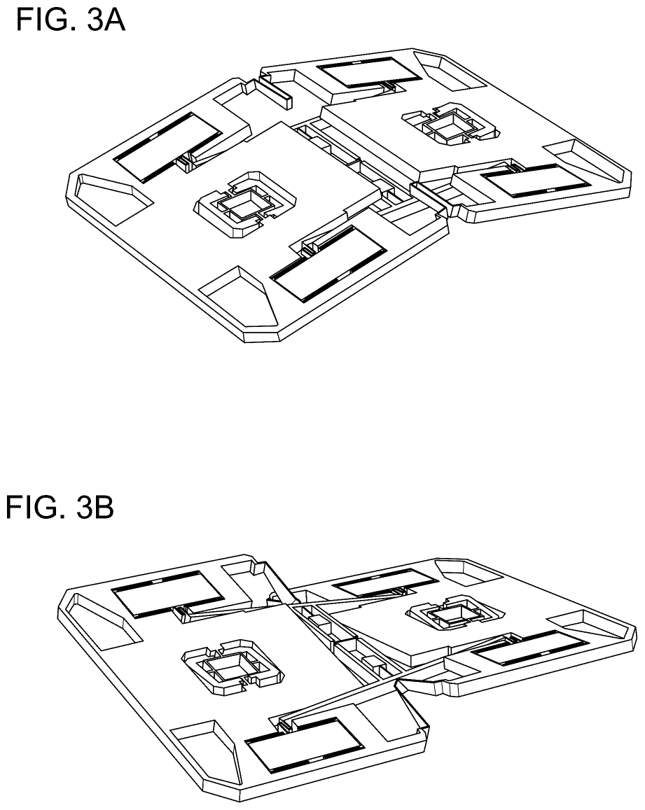

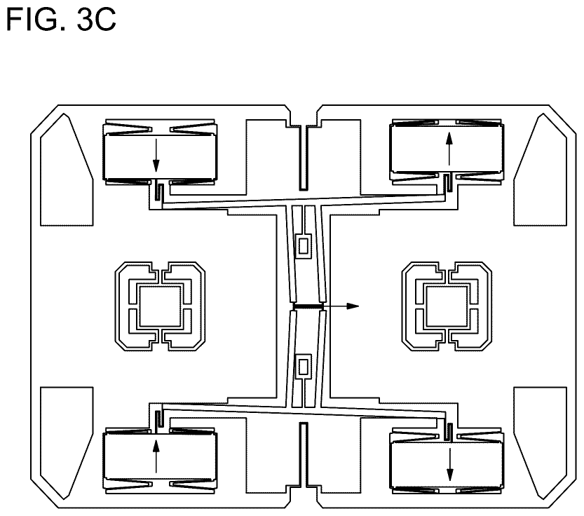

FIG. 1 shows a schematic representation of a three-axis yaw rate sensor 10 in a first embodiment according to the present invention. The illustrated three-axis yaw rate sensor 10 allows the yaw rates, i.e., the angular velocities, about three orthogonal spatial axes—an X-axis, a Y-axis and a Z-axis—to be determined simultaneously. The yaw rate sensor 10 shown can be made, for example, of silicon or silicon oxides or other semiconductors or oxides or oxide ceramics by means of physical or chemical vapor deposition processes and by means of various etching processes. A double rotor 1 is shown, which comprises a first rotor 1.1 and a second rotor 1.2. The first rotor 1.1 is connected via a first substrate connection 2.1 and the second rotor 1.2 via a second substrate connection 2.2 to a silicon substrate located, from the plan view, below the double rotor, as a result of which the distance from the silicon substrate required for the drive mode and the detection modes is provided. The silicon substrate has a main extension plane 11 which is oriented in parallel with the viewing plane of the representation. In this case, the connections between the rotors 1.1, 1.2 and the substrate connections 2.1, 2.2 each consist of two webs, which are designed in such a way that they make the torsional oscillations of the detection modes (see FIG. 3A, FIG. 3B and FIG. 3C) of the yaw rate sensor 10 possible. In addition, four free regions 9 are shown in the first and in the second rotor 1.1, 1.2, which are provided for placement of drive combs of the yaw rate sensor 10. The design and placement of the drive combs is such that they excite the two rotors 1.1, 1.2 to torsional oscillations, the axes of rotation of these torsional oscillations being perpendicular to the viewing plane. Also shown are a first and a second seismic mass 6.1, 6.2 of the first rotor 1.1 and a third and a fourth seismic mass 6.3, 6.4 of the second rotor 1.2. The seismic masses 6.1, 6.2, 6.3, 6.4 are mechanically connected to the first rotor 1.1 and to the second rotor 1.2 via two U-shaped spring elements in each case, and serve to make detection of the yaw rate about the Z-axis possible. Also shown is a first spring structure 3, which comprises U-shaped spring elements. The first spring structure 3 extends along the outer edge of the double rotor 1 and couples a drive mode of the yaw rate sensor 10 and a detection mode about the X-axis in such a way that anti-phase torsional oscillations of the rotors 1.1, 1.2 are excited by the drive (also referred to as anti-parallel drive mode), the axes of rotation of these torsional oscillations being oriented perpendicularly to the viewing plane. The coupling also causes the detection mode, which is excited by a rotation about the X-axis, to exhibit two anti-phase torsional oscillations of the rotors 1.1, 1.2 about two axes of rotation (also referred to as anti-parallel detection mode of the X-axis) which extend in parallel with the Y-axis and through the first and the second substrate connection 2.1, 2.2 (see FIG. 3A). Also shown is a second spring structure 4 which is designed as a torsion rocker and which is connected to the silicon substrate located underneath by a third and a fourth substrate connection 5.1, 5.2 on an axis of symmetry of the yaw rate sensor 10. The connection is designed in such a way that the rotors can move out of the plane. The second spring structure 4 serves to couple the detection mode for a rotation about the Y-axis to the drive mode, and the second spring structure 4 also serves as a rocker for coupling a detection mode, which is excited by a rotation about the Z-axis (see FIG. 3C), to the drive mode. For this purpose, the second spring structure 4 has a first spring element 8 which is designed as an S-shaped spring. The first spring element 8 provides a mechanical connection to a seismic mass 6.1, 6.2, 6.2, 6.4. This mechanical connection allows the deflection of the seismic mass 6.1, 6.2, 6.2, 6.4 during the drive movement and transmits the radial movements of the seismic mass 6.1, 6.2, 6.2, 6.4 to the second spring structure 4. Also shown is a second spring element 7 which is designed as an H-shaped spring and serves to mechanically couple the first and the third seismic masses 6.1, 6.3 to the second and the fourth seismic masses 6.2, 6.4. This mechanical coupling allows the torsional movements of the double rotor 1 and simultaneously makes the lateral movement for the detection of the yaw rate about the Z-axis possible.

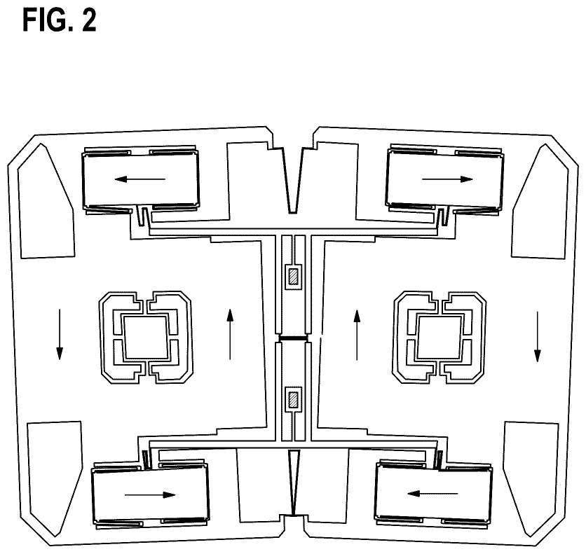

FIG. 2 shows a schematic representation of the drive mode of the yaw rate sensor 10 according to the first embodiment of the present invention in plan view. The two rotors 1.1, 1.2 (see FIG. 1) are excited to torsional oscillations, the axes of rotation of these torsional oscillations being perpendicular to the viewing plane and extending through the center points of the first and the second substrate connection 2.1, 2.2 (see FIG. 1). In the rotational movement shown, the U-shaped spring elements of the first spring structure 3 (see FIG. 1) have a suspension which is designed in such a way that the drive mode shown has two anti-phase torsional oscillations of the rotors 1.1, 1.2.

FIG. 3A shows a schematic representation of a detection mode of the three-axis yaw rate sensor 10 according to the first embodiment of the present invention, which mode is excited by a rotation about the X-axis. Due to the first spring structure 3 extending along the outer edge of the double rotor 1 (see FIG. 1), a mechanical coupling is provided, by means of which the detection mode, which is excited by a rotation about the X-axis (see FIG. 1), exhibits two anti-phase torsional oscillations of the rotors 1.1, 1.2 about two axes of rotation (also referred to as anti-parallel detection mode of the X-axis), the two axes of rotation extending in parallel with the Y-axis (see FIG. 1) and through the first and the second substrate connection 2.1, 2.2. In this detection mode, the mechanical coupling by the first spring structure 4 means that rotational accelerations about the Y-axis do not influence the measurement of the yaw rate about the X-axis.

FIG. 3B shows a schematic representation of a detection mode of the three-axis yaw rate sensor 10 according to the first embodiment of the present invention, which mode is excited by a rotation about the Y-axis (see FIG. 1). Due to the second spring structure 3 (see FIG. 1) extending across the sensor center, a mechanical coupling is provided, by means of which the detection mode, which is excited by a rotation about the Y-axis (see FIG. 1), exhibits two anti-phase torsional oscillations of the rotors 1.1, 1.2 about the X-axis (see FIG. 1), which extends through the first and the second substrate connection 2.1, 2.2. In this detection mode, the mechanical coupling by the second spring structure 4 means that rotational accelerations about the X-axis, which lead to in-phase deflections of the rotors, do not influence the measurement of the yaw rate about the Y-axis.

FIG. 3C shows a schematic representation of a detection mode of the three-axis yaw rate sensor 10 according to the first embodiment of the present invention, which mode is excited by a rotation about the Z-axis (see FIG. 1). The second spring structure 3 (see FIG. 1) extending across the sensor center provides a mechanical coupling by which the detection mode, which is excited by a rotation about the Z-axis (see FIG. 1), exhibits lateral movements of the seismic masses 6.1, 6.2, 6.3, 6.4. The two seismic masses 6.1, 6.4 are in the illustrated phase of movement and, assuming the coordinate system introduced in FIG. 1, are at negative Z-coordinate values, while the seismic masses 6.2, 6.3 are at positive Z-coordinate values. From the lateral deflection of the seismic masses 6.1, 6.2, 6.3, 6.4 occurring as a result of the movement, the yaw rate about the Z-axis can be determined, for example using capacitive or differential capacitive measuring methods.

The present invention is not limited to the above-described exemplary embodiments, but rather can be used in a wide variety of applications of inertial sensor-based navigation, orientation, and stabilization of objects. A computing unit in the sensor can be used to control the operation of the inertial sensor (e.g. power saving mode, measuring ranges), to check sensor signals for plausibility and e.g. for tolerances (e.g. for sensor-internal monitoring), to process the signals (e.g. calculating the position or orientation, filtering the data), and to select communication protocols. A wide variety of self-learning AI-based algorithms can be used in the computing unit for the evaluation and signal processing of the data from the inertial sensors, the temperature sensors and external data (e.g. GPS data, odometer data). Fields of application, by way of example, can be found in:
automotive applications (e.g. ESP, roll-over sensing, airbag, road noise suppression, anti-theft alarm, parking collision, road condition monitoring),
for two-wheelers such as motorcycle, bicycle, scooter applications (e.g. in ESP/airbag, inclination detection, balancing),
for three-wheelers such as Tuk-Tuks,
in the avionics sector (e.g. in flight stabilization and flight control),
in industrial robot applications (e.g. in position control of excavator buckets, drilling, image stabilization, flight control, alignment of satellite antennas, fine motor skills in gripping robots)
in home and garden applications (e.g. lawnmower navigation, door position monitoring)
for medical applications (e.g. fall detection, motion and posture detection)
in sports and leisure applications (e.g. motion detection, posture detection (for golf clubs, tennis rackets, skis), and in
numerous consumer applications e.g. in smartphones, tablets, wearables, hearables, drones, gaming toys, AR or VR.

Furthermore, numerous designs, changes, modifications, deviations, variations and embodiments are possible, all of which fall within the scope of the present invention.

1-10. (canceled)

11. A three-axis yaw rate sensor, comprising:
a sensor substrate;
a double rotor; and
a first spring structure and a second spring structure;
wherein the substrate has a main extension plane, the main extension plane being spanned by an X-axis and a Y-axis oriented perpendicularly to the X-axis, a Z-axis being oriented perpendicularly to the main extension plane, the double rotor has a first rotor and a second rotor, the first rotor has a first seismic mass and a second seismic mass, the second rotor has a third seismic mass and a fourth seismic mass, the first rotor being connected to the sensor substrate via a first substrate connection, the second rotor being connected to the sensor substrate via a second substrate connection, the first rotor being connected to the second rotor via the first spring structure in such a way that a first mechanical coupling is present between the first rotor and the second rotor, the first, second, third, and fourth seismic masses of the first and the second rotor being connected to one another via the second spring structure in such a way that a second mechanical coupling is present between the first, second, third, and fourth seismic masses of the first and the second rotor and the first rotor and the second rotor, the first spring structure being arranged offset with respect to the second spring structure in such a way that a first projection surface formed by perpendicular projection of the first spring structure onto the main extension plane has no common points with a second projection surface formed by perpendicular projection of the second spring structure onto the main extension plane.

12. The three-axis yaw rate sensor according to claim 11, wherein the first mechanical coupling is a mechanical coupling between a drive mode of the double rotor and a first detection mode of the three-axis yaw rate sensor, the first and second rotors executing anti-phase torsional oscillations in the drive mode, axes of rotation of the anti-phase torsional oscillations being oriented in parallel with the Z-axis, it being possible for the first detection mode to be excited by a rotation about the X-axis.

13. The three-axis yaw rate sensor according to claim 11, wherein the second mechanical coupling is a mechanical coupling of a second detection mode and/or a third detection mode, it being possible for the second detection mode to be excited by a rotation about the Z-axis, and/or it being possible for the third detection mode to be excited by a rotation about the Y-axis.

14. The three-axis yaw rate sensor according to claim 11, wherein the second spring structure has at least one first spring element which is an S-shaped spring element, using which at least one of the seismic masses is connected to the second spring structure, the at least one first spring element allowing movement of the drive mode and transmitting radial movements of the at least one seismic mass to the second spring structure.

15. The three-axis yaw rate sensor according to claim 11, wherein the second spring structure has at least one second spring element which is an H-shaped spring element, using which the first seismic mass or the third seismic mass is coupled to the second seismic mass or to the fourth seismic mass, torsional movements and lateral movements being made possible by the at least one second spring element, the lateral movements being lateral movements of a detection mode which can be excited by a rotation about the Z-axis.

16. The three-axis yaw rate sensor according to claim 11, wherein the first spring structure is arranged substantially on an outer edge of the double rotor.

17. The three-axis yaw rate sensor according to claim 11, wherein the second spring structure is arranged substantially in a center of the double rotor.

18. The three-axis yaw rate sensor according to claim 11, wherein the second spring structure includes a torsion rocker.

19. The three-axis yaw rate sensor according to claim 11, wherein the first spring structure and/or the second spring structure is made of an epitaxially grown, polycrystalline semiconductor layer.

20. The three-axis yaw rate sensor according to claim 19, wherein the layer is a silicon layer and/or the layer has a layer thickness of at least 1.8 μm.

21. The three-axis yaw rate sensor according to claim 11, wherein the first spring structure has a U-shaped spring element.
